(19) United States
(12) Patent Application Publication
(10) Pub. No.: US 2024/0322472 A1
(43) Pub. Date: Sep. 26, 2024

(54) ELECTRICAL CONNECTOR AND CONDUCTIVE TERMINAL THEREOF

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: TZU-YAO HWANG, New Taipei (TW)

(21) Appl. No.: 18/609,412

(22) Filed: Mar. 19, 2024

(30) Foreign Application Priority Data
Mar. 24, 2023 (CN) 202310301550.6

(51) Int. Cl. H01R 13/04; H01R 12/55; H01R 13/42; H01R 13/502

(52) U.S. Cl. CPC H01R 13/04; H01R 12/55; H01R 13/42; H01R 13/502

(57) ABSTRACT

An electrical connector includes an insulating housing having an upper surface, a lower surface, and plural terminal holes penetrating the upper surface and lower surface; and plural conductive terminals retained in the insulating housing and including a base, an elastic arm extending upwardly from an upper edge of the base, and a soldering portion extending downwardly from a lower edge of the base, wherein each transverse side of the base has a retaining protrusion fixed to the insulating housing, the base includes a through hole having an upper edge, a lower edge, and two opposite side edges, a first distance between the upper edge of the through hole and the upper edge of the base is greater than a second distance between the lower edge of the through hole and the lower edge of the base.

### BACKGROUND OF THE INVENTION

### Field of the Invention

The present invention relates generally to an electrical connector and conductive terminal thereof, and particularly to a socket used to connect a chip module and a printed circuit board.

### Description of Related Arts

China Patent Application Publication No. CN109066161A discloses an electrical connector, for being soldered to a printed circuit board, which includes an insulating housing and a plurality of terminals retained in the insulating housing. The terminal has a plate-like base, a contact arm extending upward from the base, a soldering portion extending downward from the base, and first retaining portions located on both sides of the base portion. An inner wall of the insulating housing has a second retaining portion for holding the first retaining portion. The soldering portion has a tin-containing hole for absorbing solder. Since the distance from the base to the tin-containing hole is short in an upper and lower direction but wide in a horizontal direction, it would result in a high stiffness coefficient of the terminal, which in turn causes a higher risk of tin cracking in the terminal. Once tin cracking occurs in the terminal, it will destroy the connection between the electrical connector and the printed circuit board, which will have a serious impact on the service life and reliability of the circuit board.

An improved electrical connector is desired.

### SUMMARY OF THE INVENTION

An object of the present invention is to provide an electrical connector with better stability after soldering to a printed circuit board.

To achieve the above-mentioned object, an electrical connector electrically for connecting a chip module to a printed circuit board includes an insulating housing having an upper surface, a lower surface, and a plurality of terminal holes penetrating the upper surface and the lower surface; and a plurality of conductive terminals retained in the terminal holes of the insulating housing and comprising a base, an elastic arm extending upwardly from an upper edge of the base and out of the upper surface, and a soldering portion extending downwardly from a lower edge of the base to the lower surface, the base having a respective retaining protrusion at each of two transverse sides thereof in a transverse direction fixed to the insulating housing, wherein the base has a through hole, the through hole has an upper edge, a lower edge, and two opposite side edges, and a first distance between the upper edge of the through hole and the upper edge of the base is greater than a second distance between the lower edge of the through hole and the lower edge of the base.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of an embodiment of the present invention, only one electrical terminal is illustrated;

FIG. 2 is a perspective view of the terminal with a soldering ball in FIG. 1;

FIG. 3 is a perspective view of the terminal in FIG. 2; and

FIG. 4 is a front view of the terminal with the soldering ball in FIG. 2.

### DETAILED DESCRIPTION OF THE PREFERRED EMBODIMENT

Reference will now be made to the drawing figures to describe the preferred embodiment of the present invention in detail.

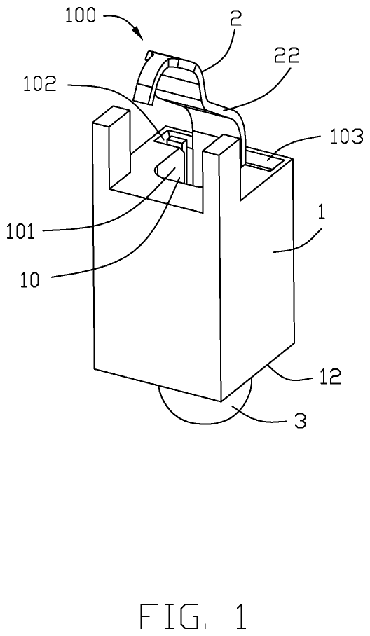

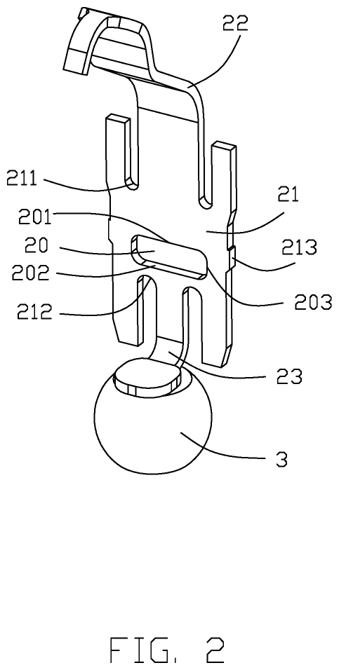

Referring to FIGS. 1-4, an electrical connector 100 of the present invention can be mounted on a printed circuit board (not shown) for electrically connecting a chip module (not shown) to the printed circuit board, the electrical connector 100 is a type of chip socket. The electrical connector 100 comprises an insulating housing 1 and a plurality of conductive terminals 2 retained in the insulating housing 1 and arranged in an array pattern, only one terminal 2 is shown in this drawings. The insulating housing 1 has an upper surface 11, a lower surface 12 opposite to the upper surface 11 and a plurality of terminal holes 10 penetrating the upper surface 11 and lower surface 12. Referring to FIGS. 2-4, the terminal 2 comprises a base 21, an elastic arm 22 extending upwardly from an upper edge 211 of the base 21 and out of the upper surface 11, and a soldering portion 23 extending downwardly from a lower edge 212 of the base 21 to the lower surface 12. Each transverse side of the base 21 comprises a retaining protrusion 213 fixed to the insulating housing 1. The terminal is assembled to and retained in the insulating housing 1 by the retaining protrusions 213 which are interfered with the insulating housing 1. The base 21 has a through hole 20 thereon. The through hole 20 has an upper edge 201, a lower edge 202 and two opposite side edges 203. A second distance D2 between the lower edge 202 of the through hole 20 and the lower edge 212 of the base 21 is shorter than a first distance D1 between the upper edge 201 of the through hole 20 and the upper edge 211 of the base 21.

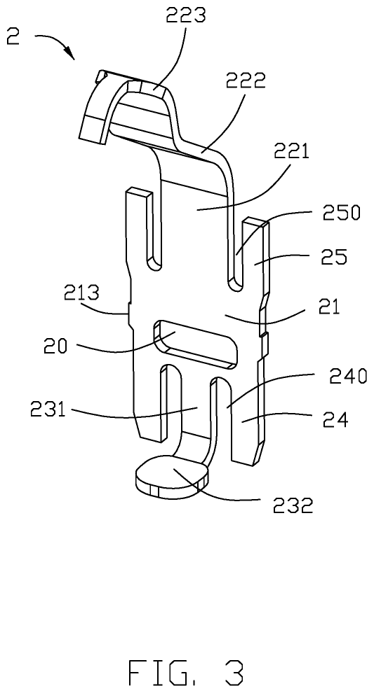

Referring to FIG. 3, the elastic arm 22 comprises a vertical portion 221 extending upward from the base 21, an inclined portion 222 extending upward from the vertical portion 221, and a contacting portion 223 bent upward from the inclined portion 222. The soldering portion 23 comprises an extension portion 321 extending vertically downward from the base 21, and a soldering pad 232 bending from the extension portion 231. The soldering pad 232 is soldered to the printed circuit board through a soldering ball 3. Currently, some terminals on the market shorten the length of the extension portion to achieve the technical effect of improving the high-frequency performance of the electrical connector while ensuring the integrity of signal transmission. However, such an arrangement will cause the extension portion to be more rigid, thus making the terminal has a higher risk of tin cracking. The terminal 2 is cut from a metal strip with a certain thickness. The second distance D2 between the lower edge 202 of the through hole 20 and the lower edge 212 of the base 21 is half to three times the thickness of the terminal 2. The length of the upper edge 202 or the lower edge 202 of the through hole 20 is at least twice the thickness of the terminal 2. The through hole 20 can reduce the rigidity of the terminal 2 while shortening the extension portion 231 to improve the high-frequency performance of the electrical connector 100, which can reduce the risk of tin cracking and help improve the service life of the electrical connector 100.

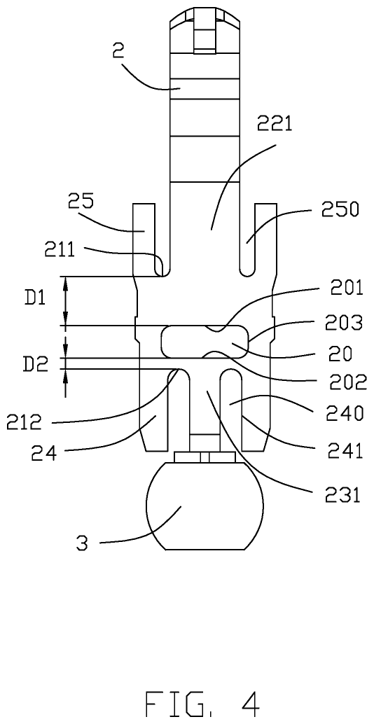

Referring to FIG. 4, the through hole 20 extends in a transverse direction, the length of the upper edge 201 or the lower edge 202 of the through hole 20 is longer than the length of the side edge 203 of the through hole 20, which can reduce the rigidity of the terminal 2 in the transverse direction and is beneficial to the stable holding of the terminal 2 in the transverse direction. The terminal 2 comprises a pair of lower arms 24 extending downward from the base 21. The pair of lower arms 24 are located on both sides of the soldering portion 23 respectively. A first gap 240 is located between the lower arm 24 and the soldering portion 23. The through hole 20 overlaps the first gap 240 viewed in an upper and lower direction. The side edge 203 of the through hole 20 extends transversely beyond an outer edge 241 of the corresponding first gap 240. The terminal 2 comprises a pair of upper arms 25 extending downward from the base 21. The pair of upper arms 25 are located on both sides of the elastic arm 22 respectively. A second gap 250 is located between the upper arm 25 and the elastic arm 22. The through hole 20 overlaps the second gap 250 viewed in the upper and lower direction.

In this embodiment, an upper end of the upper arm 25 is connected to a material strip (not shown). Referring to FIG. 1, the terminal hole 10 includes a mating hole 101 and a holding hole 102 that communicate with each other. The base 20 is disposed in the holding hole 102. The elastic arm 22 and the soldering portion 23 extend toward the mating hole 101. The soldering pad 232 is located in the mating hole 101. The holding hole 102 includes a groove portion 103 extending transversely. The upper arm 25 and the lower arm 24 are located in the groove portion 103. The retaining protrusions 213 may be disposed on the upper arm 25 or the lower arm 24. The first gap 250 and the second gap 240 may provide deformation space for retaining, which is beneficial to increasing the stability of the terminal.

Referring to FIG. 4, a transverse width of the through hole 20 is longer than a transverse width of the extension portion 231 in the transverse direction, the transverse width of the through hole 20 is longer than a transverse width of the vertical portion 221 in the transverse direction, the transverse width of the vertical portion 221 is longer than the transverse width of the extension portion 231. In this way, it is helpful to reduce the rigidity of the extension portion 231. When the elastic arm 22 is pressed down and mated with the chip module, the through hole 20 can increase the toughness of the terminal 2 in the upper and lower direction. It is beneficial to the good mating of the terminals 2 in the up-down direction.

The above-mentioned embodiments are only preferred embodiments of the present invention, and should not limit the scope of the present invention, any simple equivalent changes and modifications made according to the claims of the present invention and the contents of the description should still belong to the present invention.

1. An electrical connector comprising:
an insulating housing having an upper surface, a lower surface opposite to the upper surface, and a plurality of terminal holes penetrating the upper surface and the lower surface; and
a plurality of conductive terminals retained in the terminal holes of the insulating housing and comprising a base, an elastic arm extending upwardly from an upper edge of the base and out of the upper surface, and a soldering portion extending downwardly from a lower edge of the base to the lower surface, the base having a respective retaining protrusion at each of two transverse sides thereof in a transverse direction fixed to the insulating housing;
wherein the base has a through hole, the through hole has an upper edge, a lower edge, and two opposite side edges, and a first distance between the upper edge of the through hole and the upper edge of the base is greater than a second distance between the lower edge of the through hole and the lower edge of the base.

2. The electrical connector as claimed in claim 1, wherein the second distance is about one half to three times a thickness of the conductive terminal.

3. The electrical connector as claimed in claim 2, wherein a length of the upper edge or the lower edge of the through hole is at least twice the thickness of the conductive terminal.

4. The electrical connector as claimed in claim 1, wherein the through hole extends in the transverse direction, and the length of the upper edge or the lower edge of the through hole is longer than a length of the side edge of the through hole.

5. The electrical connector as claimed in claim 4, wherein the conductive terminal comprises a pair of lower arms extending downward from the base, the pair of lower arms are located on two opposite sides of the soldering portion respectively, a respective first gap is defined between each lower arm and the soldering portion, and the through hole overlaps the first gap viewed in an upper and lower direction.

6. The electrical connector as claimed in claim 5, wherein the side edge of the through hole is located transversely outwardly beyond an outer edge of the corresponding first gap.

7. The electrical connector as claimed in claim 4, wherein the conductive terminal comprises a pair of upper arms extending upward from the base, the pair of upper arms are located on two opposite sides of the elastic arm respectively, a respective second gap is defined between each upper arm and the elastic arm, and the through hole overlaps the second gap viewed in an upper and lower direction.

8. The electrical connector as claimed in claim 3, wherein the elastic arm comprises a vertical portion extending upward from the base, an inclined portion extending upward from the vertical portion, and a contacting portion bent upward from the inclined portion, the soldering portion comprises an extension portion extending vertically downward from the base and a soldering pad bending from the extension portion, and a transverse width of the through hole is longer than a transverse width of the extension portion in the transverse direction.

9. The electrical connector as claimed in claim 8, wherein the transverse width of the through hole is longer than a transverse width of the vertical portion in the transverse direction.

10. The electrical connector as claimed in claim 9, wherein the transverse width of the vertical portion is longer than the transverse width of the extension portion.

11. A conductive terminal comprising:
a base defining an upper edge, a lower edge, two transverse edges connecting with the upper edge and the lower edge, and a respective retaining protrusion at each transverse edge;
an elastic arm extending upwardly from the upper edge of the base; and
a soldering portion extending downwardly from the lower edge of the base;
wherein the base comprises a through hole defining an upper edge, a lower edge, and two opposite side edges, and a first distance between the upper edge of the through hole and the upper edge of the base is greater than a second distance between the lower edge of the through hole and the lower edge of the base.

12. The conductive terminal as claimed in claim 11, wherein the second distance is about one half to three times a thickness of the conductive terminal.

13. The conductive terminal as claimed in claim 12, wherein a transverse length of the upper edge or the lower edge of the through hole is at least twice the thickness of the conductive terminal.

14. The conductive terminal as claimed in claim 11, wherein the through hole extends in the transverse direction, and the length of the upper edge or the lower edge of the through hole is longer than a length of the side edge of the through hole.

15. The conductive terminal as claimed in claim 13, wherein the conductive terminal comprises a pair of lower arms extending downward from the base, the pair of lower arms are located on two opposite sides of the soldering portion respectively, a respective first gap is defined between each lower arm and the soldering portion, and the through hole overlaps the first gap viewed in an upper and lower direction.

16. The conductive terminal as claimed in claim 13, wherein the conductive terminal comprises a pair of upper arms extending downward from the base, the pair of upper arms are located on two opposite sides of the elastic arm respectively, a respective second gap is defined between each upper arm and the elastic arm, and the through hole overlaps the second gap viewed in an upper and lower direction.

17. The conductive terminal as claimed in claim 13, wherein the elastic arm comprises a vertical portion extending upward from the base, an inclined portion extending upward from the vertical portion, and a contacting portion bent upward from the inclined portion, the soldering portion comprises an extension portion extending vertically downward from the base and a soldering pad bending from the extension portion, and a transverse width of the through hole is longer than a transverse width of the extension portion in the transverse direction.

18. The conductive terminal as claimed in claim 17, wherein the transverse width of the through hole is longer than a transverse width of the vertical portion in the transverse direction.

19. An electrical connector comprising:
an insulating housing having an upper surface, a lower surface opposite to the upper surface, and a plurality of terminal holes penetrating the upper surface and the lower surface; and
a plurality of conductive terminals retained in the plurality of terminal holes and comprising a base, an elastic arm extending upwardly from an upper edge of the base and out of the upper surface, and a soldering portion extending downwardly from a lower edge of the base to the lower surface;
wherein each transverse side of the base comprises a retaining protrusion fixed to the insulating housing, and the base comprises a through hole located near the lower edge of the base.

20. The electrical connector as claimed in claim 19, wherein the through hole comprises an upper edge and a lower edge, and the distance between the lower edge of the through hole and the lower edge of the base is half to three times the thickness of the conductive terminal.
